(19) United States
(12) Patent Application Publication
(10) Pub. No.: US 2008/0283603 A1
(43) Pub. Date: Nov. 20, 2008

(54) BARCODE SCANNER OPERATOR INTERFACE

(76) Inventors: Peter Barron, Tucker, GA (US); Theodore Heske, III, Suwanee, GA (US); Mary Ryan Jones, Atlanta, GA (US); Jennie P. Johnson, Suwanee, GA (US)

Correspondence Address: Paul W. Martin;NCR Corporation, Intellectual Property Section, Law Department, 1700 South Patterson Blvd., Dayton, OH, 45479-0001, US

(21) Appl. No.: 11/748,000

(22) Filed: May 14, 2007

(51) Int. Cl. G06K 7/00

(52) U.S. Cl. 235/454

(57) ABSTRACT

A barcode scanner operator interface capable of providing enhanced information. The interface includes a visual indicator including positions capable of being individually illuminated, and control circuitry for monitoring states of the barcode scanner and for illuminating the positions of the visual indicator to produce codes indicative of the states of the barcode scanner.

### BACKGROUND

Barcode scanners typically include a simple interface including one or two light emitting diodes (LEDs) and a speaker for producing “beep” tones.

Scanner diagnostic are typically identified by a specific number code. Both visual and audio feedback representing that number code is used to indicate a specific scanner error. Use of double digit number codes result in many audio beeps or visual flashes to represent a given error which can lead to misinterpretation of the error and potentially cause a delay in correcting the error.

Current scanner displays limit the type of information and resolution of problem states for Scale Zero Indications. Users do not currently receive specific feedback regarding an off-zero scale state from the scanner when the scale is idle.

More recent innovations have incorporated the detection and deactivation of loss prevention tags into the scanner/scale. While these integrated tag deactivation devices are generally successful in detecting and deactivating electronic article surveillance (EAS) and radio frequency identification (RFID) tags, the operator does not receive feedback about the states of these tags during checkout. Typically the only feedback that an operator receives is the EAS/RFID tag sensor alarm sounding as the customer leaves the store.

It would be desirable to provide a barcode scanner operator interface that provides more information to an operator about the scanner and any systems incorporated into the scanner.

### SUMMARY

A barcode scanner operator interface is provided.

The interface includes a visual indicator including positions capable of being individually illuminated, and control circuitry for monitoring states of the barcode scanner and for illuminating the positions of the visual indicator to produce codes indicative of the states of the barcode scanner.

### BRIEF DESCRIPTION OF THE DRAWINGS

FIG. 1 is a block diagram of an example barcode scanner.

FIG. 2 is a perspective view of an example barcode scanner.

### DETAILED DESCRIPTION

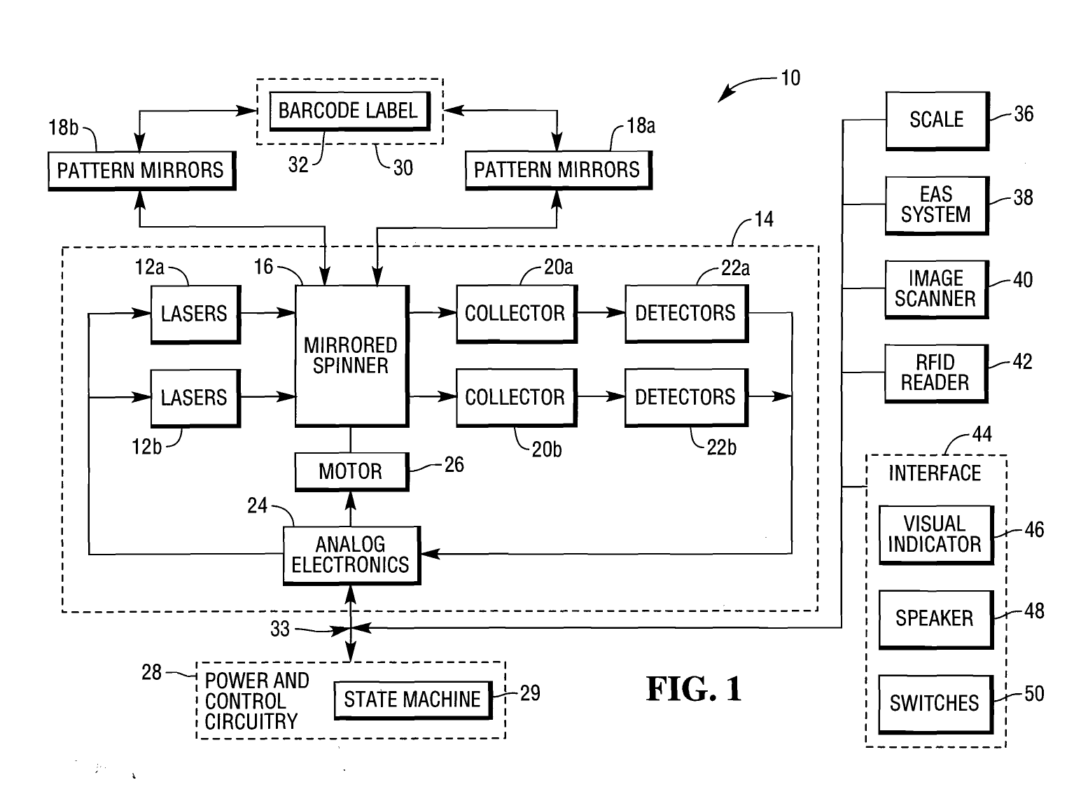

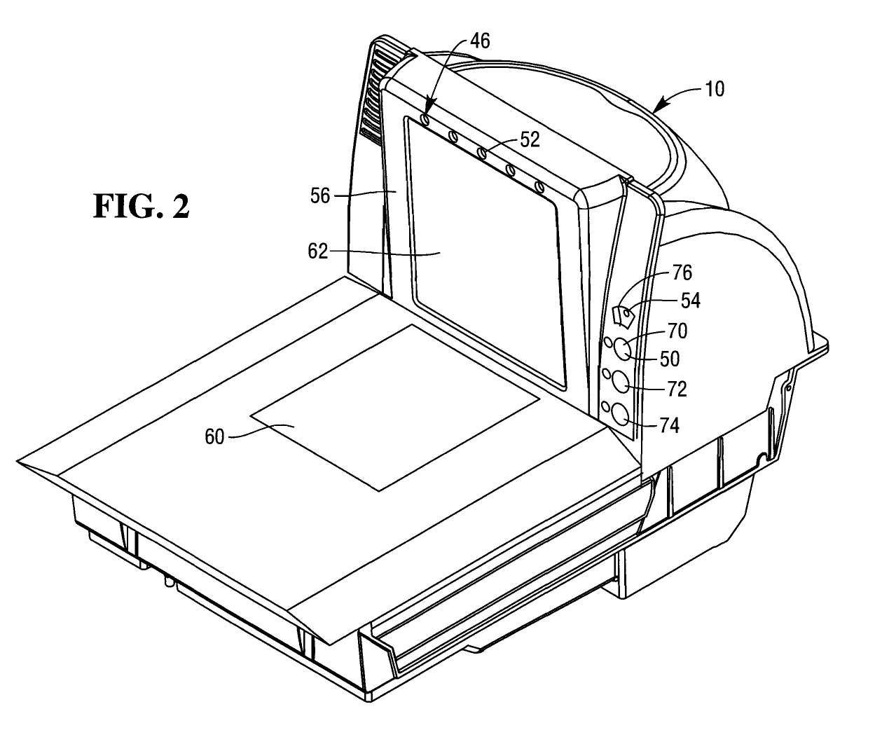

With reference to FIGS. 1-2, an example embodiment of optical scanner 10 includes optics engine 14, pattern mirrors 18a and 18b, and power and control circuitry 28. Optical scanner 10 includes a dual aperture scanner.

Optical scanner 10 may additionally include scale 36, electronic article surveillance system 38, image scanner 40, and radio frequency identification (RFID) reader 42.

Optics engine 14 includes lasers 12a and 12b, mirrored spinner 16, collectors 20a and 20b, detectors 22a and 22b, analog electronics 24, and motor 26.

Laser 12a and 12b produce laser beams. Each of lasers 12a and 12b include one ore more lasers. In the example embodiment, each of lasers 12a and 12b may include up to two lasers.

Mirrored spinner 16 directs the laser beams to pattern mirrors 18a and 18b to produce a scan pattern, and receives reflected light from item 30 from pattern mirrors 18. Motor 26 rotates mirrored spinner 16.

Collectors 20a and 20b collect the reflected light from mirrored spinner 16 and direct it towards detectors 22a and 22b.

Detectors 22a and 22b convert the reflected light into electrical signals. In the example embodiment, each of detectors 22a and 22b may include up to two detectors.

Analog electronics 24 provides drive circuitry for lasers 12a and 12b and motor 26, and amplifies and filters the electrical signals from detectors 22a and 22b.

Pattern mirrors 18a direct the laser beams from laser 12a towards bar code label 32 and direct the reflected light to mirrored spinner 16. Pattern mirrors 18b direct the laser beams from laser 12b towards bar code label 32 and direct the reflected light to mirrored spinner 16.

Power and control circuitry 28 controls operation of scanner 10 and additionally processes the processed electrical signals from analog electronics 24 to obtain information encoded in bar code label 32. Power and control circuitry 28 may include a combination of processor and memory. Power and control circuitry 28 may be connected to analog electronics 24 through one or more cables 33.

Power and control circuitry 28 includes state machine 29 for tracking scanner event signals, as well as event signals from scale 36, EAS system 38, image scanner 40, and RFID reader 42 and providing control signals to interface 44.

Power and control circuitry 28 also provides information to an operator of scanner 10 through interface 44. The information conveyed through interface 44 may include error states, operational states, and communications states of scanner 10. The information may be extended to include scale information, EAS system information, RFID reader information, multi-dimensional (2-D) reader information, loss prevention information, and other system information.

Interface 44 may include one or more sensory communication methods, such as sight, sound, and touch. As to sight, interface 44 includes a visual indicator 46 having a plurality of different positions capable of being illuminated. Collectively, the different illuminated positions form a code that conveys to an operator the state of scanner 10. Visual indicator 46 may include a light bar (FIG. 2) or a liquid crystal display.

With reference to FIG. 2, example scanner 10 is illustrated as a bi-optic scanner, having a horizontal aperture 60 and a vertical aperture 62. Visual indicator 46 is illustrated as a light bar having a row of lights 52 along a bezel 56 of scanner 10.

Switches 50 are also located on bezel 56. Lights 54 adjacent switches 50 provide feedback to an operator, indicating that a switch has been successfully activated. Lights 52 and 54 may each include one or more light emitting diodes (LEDs).

In an example embodiment, lights 52 may include a multi-color LEDs having elements for producing different colors. Each element may be individually turned on or off or controlled for intensity such that a rainbow of colors may be achieved. Alternatively, each of lights 52 may include a cluster of individual different colored LEDs.

Because the LEDs are individually controlled, light bar 46 may display both static and dynamic light patterns. Static light patterns are particularly well suited to displaying state information, whereas dynamic light patterns are particularly well suited for displaying dynamic events.

For example, static light patterns may be used to display the various states of scanner 10 and its systems. For scanner 10, these states include individual scanner error states (e.g., SCANNER_FATAL, SCANNER_NON_FATAL, SCALE_FATAL, SCALE_NON_FATAL), scanner operational states (e.g., IDLE, SLEEP, FLASH, MANUFACTURING_TEST), and scanner communications states (e.g., DISABLE, DISABLE_w/o_INDICATION).

As another example, dynamic light patterns may be used to indicate events in any of the systems (e.g., GOOD_READ, EAS_DEACTIVATION, RFID_GOOD_READ, SECOND_ITEM_SCAN). Dynamic light patterns have the advantage of being eye-catching. Timing and intensity characteristics of dynamic light patterns may be tailored so as to enhance human perception of system events.

State machine 29 controls dynamic light patterns. Processing and control circuitry 28 starts state machine 29 in response to predetermined scanner event signals, as well as event signals from scale 36, EAS system 38, image scanner 40, and RFID reader 42. State machine 29 runs autonomously until the light pattern self terminates. Afterwards, processing and control circuitry 28 causes lights 52 to display a light pattern associated with a current state.

In order to address the needs of those who may have color blindness issues, error reporting may be multifunctional. For example, lights 52 may indicate errors simultaneously in two different ways. First, lights 52 may display a unique color pattern associated with an error. Second, lights 52 may blink according to a unique blink pattern associated with the error. A color blind person may count the number of times the light pattern blinks, along with the number of lights 52 that are lit. This information then allows the color blind person to correctly identify the specific error without regard to the actual color of lights 52.

Lights 52 may be arranged in a linear fashion so as to be read from left-to-right or right-to-left. Example states of scanner 10, scale 36, and EAS system 38 are illustrated in Tables I-III. Example error condition light patterns for scanner and scale errors are illustrated in Tables IV-VII. The first light position identifies the type of error and the remaining light positions identify specific error codes. Similar methods may be used to represent all error, operational, and communication states of scanner 10 and its systems.

TABLE I

| | | | | | | |
|---|---|---|---|---|---|---|
| | LED | | | Active | Speech | When |
| State | color | Level | Activity | LEDs | Tone | activate |

a - Scanner operation states

| | | | | | |
|---|---|---|---|---|---|
| Idle (i.e. | Green | Dim | solid | 3 | |
| Enabled) | | | | center | |
| Enabled & | Green | Dim | solid | 1 | |
| Asleep | | | | center | |
| Mode | | | | LED | |
| Good | Green | Bright | solid | 5 LEDs | Dynamic |
| Scan | | | | | Lightbar |
| | | | | | Pattern |
| Disabled | Red | Bright | solid | 5 LEDs | Test with a |
| & Awake | | | | | Not on File |
| | | | | | to see if |
| | | | | | this is |
| | | | | | appropriate |
| Disabled | Red | Dim | solid | 1 | |
| and | | | | Center | |
| Asleep | | | | LED | |

b - Scanner window states

| | | | | |
|---|---|---|---|---|
| Dirty | Orange | Off, | flashing | 1 LED |
| window | | bright | | |
| Clean | | | OFF | |
| window | | | | |

c - Scanner volume states

| | | | | | |
|---|---|---|---|---|---|
| Volume | Orange | bright | solid | 1 LED | volume |
| adjust | | | | | increments |
| | | | | | with each |
| | | | | | touch, dim |
| | | | | | and solid |
| Tone | Orange | bright | solid | 1 LED | tone |
| adjust | | | | | increments |
| | | | | | while |
| | | | | | holding |
| | | | | | button |
| | | | | | down |
| Idle | | | OFF | | |

d - Scanner manual deactivation state

| | | | | | |
|---|---|---|---|---|---|
| Manual | Orange | dim | solid | 1 LED | click; |
| deactivate | | | | | bright |
| | | | | | and solid |

TABLE IV

| | | | | | | |
|---|---|---|---|---|---|---|
| | LED | | | Active | Speech, | When |
| State | color | Level | Activity | LEDs | Tone | activate |

Scale states

| | | | | | |
|---|---|---|---|---|---|
| At zero | Orange | Dim | solid | 1 | |
| (stable) | | | | button | |
| Unstable | | | OFF | | |
| w/weight | | | | | |
| Stable w/ | Orange | Bright | solid | 1 | |
| weight | | | | button | |
| Underzero | Orange | Off | flashing | 1 | click; |
| weight | | bright | | button | dim and |
| (stable) | | | | | solid |

EAS system states

| | | | | | | |
|---|---|---|---|---|---|---|
| EAS | Orange | bright | flash | 5 LEDs | Different | Dynamic |
| deactivate | | | | | tones than | Lightbar |
| | | | | | for | Pattern |
| | | | | | scanning. | |
| | | | | | Freq (Hz): | |
| | | | | | 601, 667, | |
| | | | | | 741, 824, | |
| | | | | | 914, 1016, | |
| | | | | | 1129, | |
| | | | | | 1245 Tone | |
| | | | | | length | |
| | | | | | (ms): | |
| | | | | | 15–225 | |
| | | | | | ms at | |
| | | | | | 15 ms | |
| | | | | | intervals | |
| ScanMax- | Orange | dim | solid | 1 | “EAS | If box |
| Pro box - | | | | button | Online” | comes |
| Online | | | | | (once) | back |
| | | | | | | online |
| | | | | | | after |
| | | | | | | being |
| | | | | | | offline |
| | | | | | | (below), |
| | | | | | | speak |
| | | | | | | once |
| ScanMax- | Orange | dim | flash | 1 | “EAS | at |
| Pro box - | | | (double | button | Offline” - | scanner |
| Online to | | | flash, | | once | enable, |
| Offline | | | pause, | | | when last |
| | | | double | | | disable |
| | | | flash) | | | is > “X” |
| | | | | | | minutes |
| | | | | | | ago. |
| ScanMax- | | | | | “EAS | at |
| Pro box - | | | | | Offline” | scanner |
| Offline | | | | | | enable, |
| | | | | | | when last |
| | | | | | | disable |
| | | | | | | is > “X” |
| | | | | | | minutes |
| | | | | | | ago. |

Scanner errors

| Blinks | Problem | Suspect Component |
|---|---|---|
| 0 | No LED | Power Supply/PCB |
| | | Assembly |
| 2 | RAM test failed | PCB Assembly |
| 5 | Motor too Slow | Motor |
| 6 | Bad non-volatile memory (EEPROM) | PCB Assembly |
| 7 | Slave Processor Failure | PCB Assembly |
| 9 | IBM mode | IBM mode |
| 11 | Laser not turned on | PCB Assembly |
| 12 | Program (ROM sum-check) Test failed | PCB Assembly |
| 13 | FPGA Failed To Program | PCB Assembly |

TABLE V
Light patterns for scanner errors

| Blinks | LED 1 | LED 2 | LED 3 | LED 4 | LED 5 |
|---|---|---|---|---|---|
| 0 | RED | ORANGE | | | |
| 1 | RED | ORANGE | ORANGE | | |
| 2 | RED | ORANGE | ORANGE | ORANGE | |
| 3 | RED | ORANGE | ORANGE | ORANGE | ORANGE |
| 4 | RED | BLUE | | GREEN | GREEN |
| 5 | RED | BLUE | BLUE | | |
| 6 | RED | BLUE | BLUE | BLUE | |
| 7 | RED | BLUE | BLUE | BLUE | BLUE |
| 8 | RED | GREEN | | GREEN | GREEN |
| 9 | RED | GREEN | GREEN | | |
| 10 | RED | GREEN | GREEN | GREEN | GREEN |
| 11 | RED | GREEN | GREEN | GREEN | GREEN |
| 12 | RED | RED | | | |
| 13 | RED | RED | RED | | |
| 14 | RED | RED | RED | RED | |
| 15 | RED | RED | RED | RED | RED |

TABLE VI
Scale errors (continued)

| Blinks | Problem | Suspect Component or Corrective Action |
|---|---|---|
| Scale | Scale Top | 1. Press Scale zero button. |
| Display is | Plate or | 2. Remove interference around edge of scale top |
| Blank | Produce Guard | plate or Scale product guard and scanner front |
| | has possible | bezel. |
| | obstruction. | 3. Remove any foreign objects from under the |
| | | scale top plate. |
| 1, 2, or 3 | Possible out | Calibration error. If error code persists, |
| | of range | check: |
| | calibration | 1. Scale cables and power supply. |
| | error. | 2. Digital board. |
| | | 3. Load Cell. |
| 4 | Scale | Check for objects interfering with scale |
| | Hardware | calibration switch button. Then recalibrate. |
| | Error | If error code persists, check: |
| | | 1. Calibration switch or wiring |
| | | 2. Scale cables |
| | | 3. Digital board. |
| | | Press Scale Zero button and retry. If error |
| | | persists, verify if unit is a scanner/scale |
| | | unit. If scanner-only unit, reprogram unit |
| | | (PM + 3 + 0 + 4 + S&R). If it is a scanner/scale unit and |
| | | the error continues, check: |
| | | 1. Scale cables and power supply |
| | | 2. Digital board. |
| | | 3. Load cell. |
| 5 | Scale Drift. | Ensure that nothing is on the scale. Lift the |
| | | Scale Top Plate and ensure that no objects are |
| | | under it. Press Scale Zero button. If error |
| | | code persists, check: |
| | | 1. Scale cables and power supply |
| | | 2. Digital board. |
| | | 3. Load cell. |
| 6 | Failure to | Power cycle the unit and recalibrate the scale. |
| | update | If error code persists, check the digital board. |
| | parameters | |
| | into the | |
| | EEPROM. | |
| 7 | Error Reading | Calibrate the scale. If error code persists, |
| | parameters | check the digital board. |
| | from EEPROM. | |
| 8 | Scale was not | Press on the scale during calibration procedure, |
| | properly | keep pressing on the scale until all Red LEDs |
| | exercised | turn to BLUE. Repeat procedure. |
| 9 | Linearity | Remove interference around the edge of scale top |
| | problem or | plate and checkstand or scale produce guard and |
| | Slight | scanner front bezel. |
| | vibration | Then calibrate the scale. If error code |
| | noted while | persists: |
| | scale is | 1. Scale cables and power supply |
| | being | 2. Digital board |
| | calibrated | 3. Load cell |
| | (zero drift). | Weigh plate is touching checkstand, or scale was |
| | | bumped or jarred, recalibrate. |

TABLE VII
Light patterns for scale errors

| Blinks | LED 1 | LED 2 | LED 3 | LED 4 | LED 5 |
|---|---|---|---|---|---|
| 0 | BLUE | ORANGE | | | |
| 1 | BLUE | ORANGE | ORANGE | | |
| 2 | BLUE | ORANGE | ORANGE | ORANGE | |
| 3 | BLUE | ORANGE | ORANGE | ORANGE | ORANGE |
| 4 | BLUE | RED | | | |
| 5 | BLUE | RED | RED | | |
| 6 | BLUE | RED | RED | RED | |
| 7 | BLUE | RED | RED | RED | RED |
| 8 | BLUE | GREEN | | GREEN | GREEN |
| 9 | BLUE | GREEN | GREEN | | |
| 10 | BLUE | GREEN | GREEN | GREEN | GREEN |
| 11 | BLUE | GREEN | GREEN | GREEN | GREEN |
| 12 | BLUE | BLUE | | | |
| 13 | BLUE | BLUE | BLUE | | |
| 14 | BLUE | BLUE | BLUE | BLUE | |
| 15 | BLUE | BLUE | BLUE | BLUE | BLUE |

Just as lights 52 may be used to indicate static and dynamic light patterns, to indicate scanner/scale states and events respectively, speaker 48 may be used in an analogous fashion.

For example, processing and control circuitry 28 may play unique sound files, such as WAV files, that are associated with different events.

Switches 50 may include non-contact proximity sensing switches, without moving parts. Switches include a scale zeroing switch 70, a volume control switch 72, and a customizable switch 74. Also illustrated is a window glass needs cleaning icon and an indicator light 54.

Lights 54 provide operator feedback to indicate touch information. When switches 50 are not being activated by an operator, lights 54 are in a dim state. When power and control circuitry 28 senses operator activation, power and control circuitry 28 increases the intensity of lights 54 to a bright state. Light intensity modulation replaces a tactile sensation one would otherwise receive with a push action switch.

An additional capability has been added to light 54 adjacent to scale-zeroing switch 70. When scale 36 is stable at a zero weight, light 54 provides operator feedback about the state of switch 70. However, when scale weight is unstable, light 54 is in an off state. When scale weight is stable and above zero, light 54 is in a dim state. When scale weight is stable and less than zero, light 54 is in a blinking state.

Switch 74 is customizable. For example, switch 74 may be used for manual activation of EAS system 38. Other capabilities are achievable as the retailer's needs dictate.

Although particular reference has been made to certain embodiments, variations and modifications are also envisioned within the spirit and scope of the following claims.

What is claimed is:

1. A barcode scanner comprising:
a visual indicator including positions capable of being individually illuminated; and
control circuitry for monitoring states of the barcode scanner and for illuminating the positions of the visual indicator to produce codes indicative of the states of the barcode scanner.

2. The barcode scanner of claim 1, wherein the visual indicator comprises a liquid crystal display.

3. The barcode scanner of claim 1, wherein the visual indicator comprises a plurality of lights.

4. The scanner of claim 3, wherein the plurality of lights are arranged in a row.

5. The scanner of claim 3, wherein the plurality of lights are of multiple colors.

6. The scanner of claim 1, wherein the states include static and dynamic states.

7. The scanner of claim 6, wherein the states include error states, operational states, and communications states.

8. The scanner of claim 1, further comprising:
a scale;
wherein the control circuitry is additionally for monitoring states of the scale and for illuminating the positions of the visual indicator to produce other codes indicative of the states of the scale.

9. The scanner of claim 1, further comprising:
an electronic article surveillance system;
wherein the control circuitry is additionally for monitoring states of the electronic article surveillance system and for illuminating the positions of the visual indicator to produce other codes indicative of the states of the electronic article surveillance system.

10. The scanner of claim 1, further comprising:
a radio frequency identification reader;
wherein the control circuitry is additionally for monitoring states of the radio frequency identification reader and for illuminating the positions of the visual indicator to produce other codes indicative of the states of the radio frequency identification reader.

11. The scanner of claim 1, further comprising:
an image scanner;
wherein the control circuitry is additionally for monitoring states of the image scanner and for illuminating the positions of the visual indicator to produce other codes indicative of the states of the image scanner.

12. The scanner of claim 1, further comprising:
sound circuitry;
wherein the control circuitry is also for providing an aural indication to the operator of the states of the barcode scanner through the sound circuitry.

13. The scanner of claim 1, wherein the control circuitry comprises a state machine.

14. The scanner of claim 1, further comprising:
a first portion including a generally horizontal aperture through which first scanning light beams pass; and
a second portion including a generally vertical aperture through which second scanning light beams pass;
wherein the visual indicator is mounted above the generally vertical aperture.

15. A barcode scanner comprising:
a first portion including a generally horizontal aperture through which first scanning light beams pass;
a second portion including a generally vertical aperture through which second scanning light beams pass;
a visual indicator above the generally vertical aperture including positions capable of being individually illuminated as multiple colors;
a scale; and
control circuitry including a state machine for monitoring states of the barcode scanner and the scale and for illuminating the positions of the visual indicator to produce codes indicative of the static and dynamic states of the barcode scanner and the scale.

16. The scanner of claim 15, further comprising:
an electronic article surveillance system;
wherein the control circuitry is additionally for monitoring states of the electronic article surveillance system and for illuminating the positions of the visual indicator to produce other codes indicative of the states of the electronic article surveillance system.

17. The scanner of claim 15, further comprising:
a radio frequency identification reader;
wherein the control circuitry is additionally for monitoring states of the radio frequency identification reader and for illuminating the positions of the visual indicator to produce other codes indicative of the states of the radio frequency identification system.

18. The scanner of claim 15, further comprising:
an image scanner;
wherein the control circuitry is additionally for monitoring states of the image scanner and for illuminating the positions of the visual indicator to produce other codes indicative of the states of the image scanner.

19. The scanner of claim 15, wherein the visual indicator comprises:
a row of lights;
wherein a first light position identifies an error type and remaining light positions identify a specific error of the error type.

20. The scanner of claim 19, wherein the first light position is capable of displaying a plurality of different colors, and wherein the error type is associated with one of the different colors.
